(19) United States
(12) Patent Application Publication
(10) Pub. No.: US 2017/0258072 A1
(43) Pub. Date: Sep. 14, 2017

(54) Stabilized Tree Platform

(71) Applicant: Jason Kaye, Houston, TX (US)

(72) Inventor: Jason Kaye, Houston, TX (US)

(21) Appl. No.: 15/068,399

(22) Filed: Mar. 11, 2016

(51) Int. Cl. A01M 31/02; E04G 5/04; F16M 13/02

(52) U.S. Cl. CPC A01M 31/02; F16M 13/02; E04G 5/04

(57) ABSTRACT

This invention relates generally to systems and methods for delivering a tree hunter, arborist, nature photographer, or anyone else that spends considerable time in trees, the ability to create a solid platform from which to stand on and/or maneuver around while aloft in a tree. More specifically, employing a unique lashing system of rope and cam strap, the novel platform is stable, easy to install and uninstall, and is non-damaging to a tree unlike prior art alternatives.

### BACKGROUND OF THE INVENTION

This invention relates generally to systems and methods for delivering a tree hunter, arborist, nature photographer, or anyone else that spends considerable time in trees, the ability to create a solid platform from which to stand on and/or maneuver around while aloft in a tree. More specifically, employing a unique lashing system of rope and cam strap, the novel platform is stable, easy to install and uninstall, and is non-damaging to a tree unlike prior art alternatives. Although this invention will generally be described as being used in a tree by a hunter, it can also be used on any tall pole like structure regardless of its shape and by anyone wishing to spend any significant time elevated in that structure.

Arbor enthusiasts spend an incredible amount of time in trees. Whether they are there to observe nature, hunt, photograph, or anything else, they will spend an extended period of time in the canopy of a tree. While there are multiple apparatuses that lend themselves to prolonged aerial stays, all of them fall short to the present invention in some fashion.

Historically, tree platforms were permanent or semi-permanent structures which required extensive setup time and often resulted in harm to the tree. U.S. Pat. No. 4,411,335 claims such an apparatus. These platforms were built in an elevated position and drove nails in the tree trunk to provide steps to gain access to the stand. Additionally, prior art like this is bulky and minimizes the mobility of the user.

Eventually, temporary platforms emerged on the market. While these would typically solve one shortcoming, they would do so at the cost of another critical aspect of the design. Those apparatuses which were able to limit harm to the trees would sacrifice stability like U.S. Pat. Nos. 5,257,677 and 5,156,096. Others would concentrate on a minimalist design in order to maximize ease of setup and ability to transport like U.S. Pat. Nos. 5,979,603 and 8,074,770. However, these designs not only were not safe due to minimal contact with the tree but also would greatly hinder the mobility of the hunter once he was in the tree and on the platform. Still other designs like U.S. Pat. No. 6,719,093 would concentrate on stability and safety of the tree but would completely ignore ease of setup and aerial movement of the hunter.

### SUMMARY OF THE INVENTION

The present invention gives a tree hunter, arborist, nature photographer, or anyone else that spends considerable time in trees or on poles, the ability to create a solid platform from which to stand on and/or maneuver around while aloft in a tree. Far more stable than unwieldy strap on steps, and made of lightweight materials, featuring a unique lashing system of rope and cam strap, the platform is easy to install and uninstall, and is non-damaging to a tree unlike invasive screw in tree step alternatives. Once the platform is affixed to the tree, a unique bark surface leveraging design allows the platform to be virtually immovable, completely stable, and secure on the tree to which it is attached. While the system only requires one station to be utilized, when multiple stations are employed, the comfort and quiet and easy maneuverability of the user are exponentially increased.

### BRIEF DESCRIPTION OF DRAWINGS

FIG. 1: An image of the apparatus in a preferred embodiment

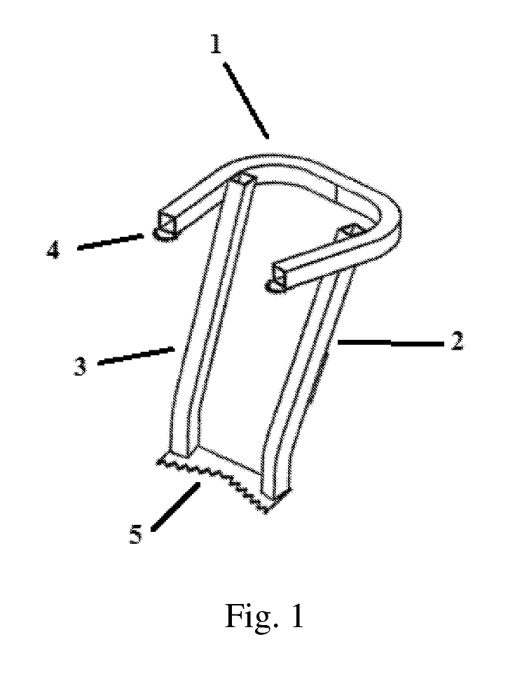

FIG. 2: A top view of the apparatus in a preferred embodiment

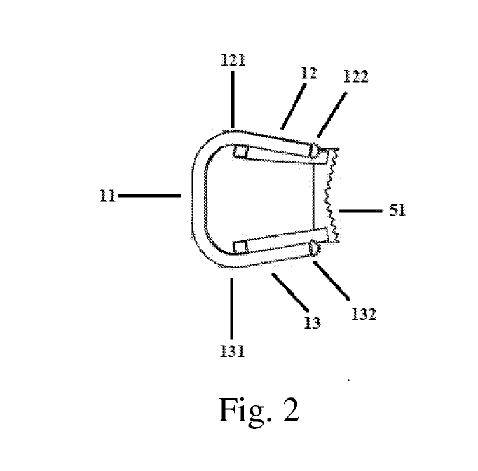

FIG. 3: A front view of the apparatus in a preferred embodiment

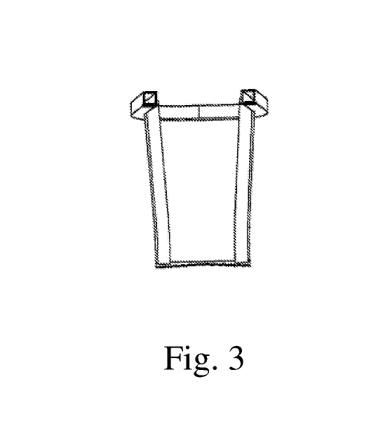

FIG. 4: A side view of the apparatus in a preferred embodiment

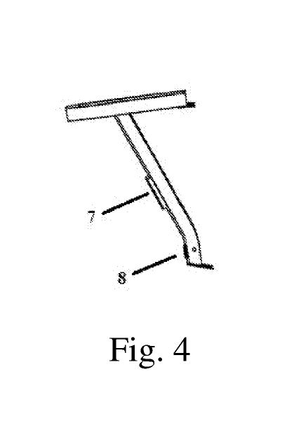

FIG. 5: Multiple views of another embodiment

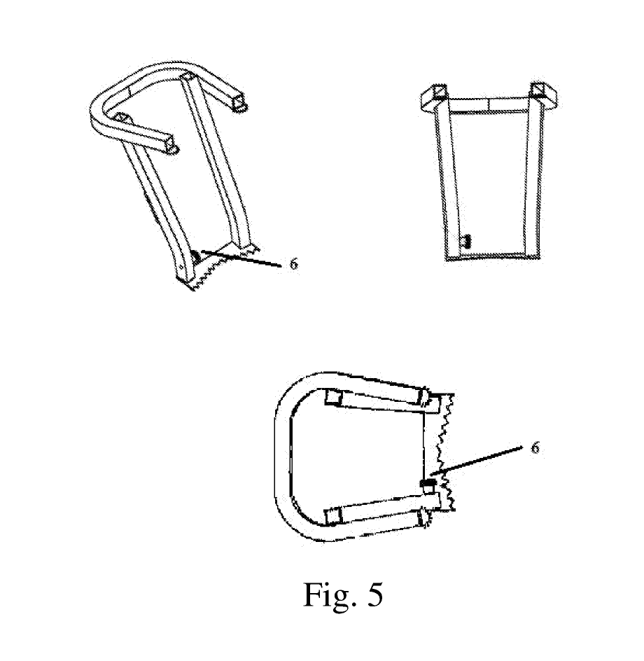

### DETAILED DESCRIPTION OF PREFERRED EMBODIMENTS

The present invention gives a tree hunter, arborist, nature photographer, or anyone else that spends considerable time in trees or on poles, the ability to create a solid platform from which to stand on and/or maneuver around while aloft in a tree. In its preferred embodiment, the apparatus provides for unparalleled stability when compared to the prior art without sacrificing its ease of installation and minimizing damage to the tree it is attached.

In a preferred embodiment, the disclosed apparatus is comprised of a horseshoe member (1), right (2) and left vertical members (3), upper bark surface leveraging systems (4), and lower bark surface leveraging system (5). In this embodiment, the horseshoe member is further comprised a the base (11) and two arms (12 and 13) and is generally U shaped and fabricated from square metal tubing. While the optimal size can vary based on the shoe size of the user, the preferred size of the arms are roughly four and a half inches and the base is eight inches. These dimensions create sufficient room to place both feet on the horseshoe member while maintaining optimal stability and space between the user and the tree when installed and transportability when not installed.

The two vertical members connect to the horseshoe member at the end of the horseshoe member's arms (121 and 131) closest to the horseshoe member's base. While multiple methods of attaching the horseshoe member to the vertical members can be utilized, including but not limited to nuts and bolts, the preferred method is to weld the members together.

The upper and lower bark surface leveraging systems are further comprised of a leading edge which provides stabilizing friction between the apparatus and a tree that does not pierce through the bark of the tree.

In one embodiment, the upper bark surface leveraging edges are further comprised of a sawtoothed semicircle on the end of a rectangular sheet of metal. Each of the upper bark surface leveraging edges connect to the ends of the arms (122 and 132) of the horseshoe members. While any means of connectivity is sufficient, the preferred means is to weld the rectangular sheet of the bark biter to the bottom of each arm of the horseshoe member.

In another embodiment, the upper bark surface leveraging edges are further comprised of at least one spike. The spike can be formed by cutting a triangular piece from at least one side each of the horseshoe member arms. In the preferred embodiment the apparatus is comprised the horseshoe member is further comprised of square metal tubing and a triangular cutout is made on each side of the horseshoe member arms to create four spikes on each arm.

The lower bark biter is further comprised of a leading edge (51) capable of providing stabilizing friction between the apparatus and a tree that does not puncture through the bark of the tree and is similarly connected to the bottom of the vertical members. Any shape which maximizes contact with the horseshoe member while providing contact with the tree is sufficient. However, a saw toothed concaved leading edge is utilized in the preferred embodiment to ensure constant contact with the tree no matter the tree's irregular shape.

While the system only requires one station to be utilized, when multiple stations are employed, the comfort and quiet and easy maneuverability of the user are exponentially increased. Once the platform is affixed to the tree, the platform is virtually immovable, and is completely stable and secure on the tree to which it is attached.

The apparatus can be lashed to the tree using any chain or rope. However, the preferred means of doing so utilizes a braided nylon rope which will maximize the strength and stability of the apparatus while minimizing the load a hunter would have to haul up the tree. Additionally, the platform can be secured to the tree in a variety of manners, but the preferred method is to loop the braided nylon rope around the left vertical member through the braids of the rope then back into the hollow of the rope. Utilizing a hollow threading tool will greatly ease this process. Then the apparatus should be positioned in a manner such that the bark surface leveraging edges are all in contact with the tree. Once positioned, wrap the rope around the tree then feed the rope inside and around the right side vertical member, up, through and over the horseshoe member, and then back down through the loop that the first two actions have produced. Then the lashings can be made snug by adjusting the knot and the length of the rope until the station is solidly secured to the tree at the top of the station.

In another embodiment of the invention, the next and final part of securing the entire apparatus to the tree is to attach a cam strap that has a loop at both ends and a spring loaded cam mechanism towards one end of the strap. Much like a slip knot, a noose is made by running one end of the strap through the loop at the other end of the strap while encircling the left side vertical member of the “base” station, then circling the entire tree while overlapping the bottom of all the vertical member of each additional “satellite” station utilized, coming all the way around and across the base station, attaching the looped end of the strap to the attachment knob (6) on the inside of the right vertical member of the “satellite” station immediately clockwise to the “base” station, and then cinching the cam strap as tight as is physically possible.

In yet another embodiment of the invention, rubber stoppers (7 and 8) are placed on the rear of the vertical members. These rubber stoppers will allow the user to stack multiple units together without fear of them becoming damaged by banging or scratching against each other.

What is claimed is:

1) An apparatus forming a stabilized tree platform comprised of a horseshoe member, a right and left vertical member, an upper bark surface leveraging system, and a lower bark surface leveraging edge where:
a) The horseshoe member is further comprised of a first and second arm and a base, where the base and arms are generally arranged in a U shape,
b) The right and left vertical members connect to the horseshoe member at the end of the horseshoe member's arms closest to the horseshoe member's base,
c) The upper bark surface leveraging system is further comprised of a leading edge capable of providing stabilizing friction between the apparatus and a tree that does not puncture through the bark of the tree and is connected to the first and second arms;
d) The lower bark biter is further comprised of a leading edge capable of providing stabilizing friction between the apparatus and a tree that does not puncture through the bark of the tree and is connected to the bottom of the vertical members.

2) The apparatus of claim 1 further comprising an attachment knob on the inside wall of at least one of the right or left vertical member.

3) The apparatus of claim 1 further comprising at least one rubber stopper connected to the rear of the vertical members.

4) The apparatus of claim 2 further comprising at least one rubber stopper connected to the rear of the vertical members.

5) A method of securing at least one apparatus of claim 1 to a tree or other columnar object comprising securing a rope or chain to the left side vertical member, positioning the apparatus in a manner such that the upper and lower bark surface leveraging systems are all in contact with the tree, wrapping the rope or chain around the tree, feeding the rope or chain inside and around the right side vertical member, up, through and over the horseshoe member, and then back down through the loop that the first two actions have produced, then the lashings can be made snug by adjusting the knot and the length of the rope until the station is solidly secured to the tree at the top of the station.

6) A method of securing at least one apparatus of claim 2 to a tree or other columnar object comprising securing a rope or chain to the left side vertical member, positioning the apparatus in a manner such that the upper and lower bark surface leveraging systems are all in contact with the tree, wrapping the rope or chain around the tree, feeding the rope or chain inside and around the right side vertical member, up, through and over the horseshoe member, and then back down through the loop that the first two actions have produced, then the lashings can be made snug by adjusting the knot and the length of the rope until the station is solidly secured to the tree at the top of the station.

7) A method of securing at least one apparatus of claim 3 to a tree or other columnar object comprising securing a rope or chain to the left side vertical member, positioning the apparatus in a manner such that the upper and lower bark surface leveraging systems are all in contact with the tree, wrapping the rope or chain around the tree, feeding the rope or chain inside and around the right side vertical member, up, through and over the horseshoe member, and then back down through the loop that the first two actions have produced, then the lashings can be made snug by adjusting the knot and the length of the rope until the station is solidly secured to the tree at the top of the station.

8) A method of securing at least one apparatus of claim 4 to a tree or other columnar object comprising securing a rope or chain to the left side vertical member, positioning the apparatus in a manner such that the upper and lower bark surface leveraging systems are all in contact with the tree, wrapping the rope or chain around the tree, feeding the rope or chain inside and around the right side vertical member, up, through and over the horseshoe member, and then back down through the loop that the first two actions have produced, then the lashings can be made snug by adjusting the knot and the length of the rope until the station is solidly secured to the tree at the top of the station.

9) The method in claim 6 further comprising the utilization of a cam strap that has a loop at both ends and a metal, spring loaded cam mechanism towards one end of the strap by making a noose at one end of the cam strap by running the same end of the strap through the loop at the other end of the strap while encircling the left side vertical member of the apparatus, then circling the entire tree while overlapping the bottom of all the vertical members of each additional station, coming all the way around and across the apparatus, attaching the looped end of the strap to the attachment knob on the inside of the right vertical member of the station immediately clockwise to the apparatus, and then cinching the cam strap as tight as is physically possible.

10) The method in claim 7 further comprising the utilization of a cam strap that has a loop at both ends and a metal, spring loaded cam mechanism towards one end of the strap by making a noose at one end of the cam strap by running the same end of the strap through the loop at the other end of the strap while encircling the left side vertical member of the apparatus, then circling the entire tree while overlapping the bottom of all the vertical members of each additional station, coming all the way around and across the apparatus, attaching the looped end of the strap to the attachment knob on the inside of the right vertical member of the station immediately clockwise to the apparatus, and then cinching the cam strap as tight as is physically possible.

11) The method in claim 8 further comprising the utilization of a cam strap that has a loop at both ends and a metal, spring loaded cam mechanism towards one end of the strap by making a noose at one end of the cam strap by running the same end of the strap through the loop at the other end of the strap while encircling the left side vertical member of the apparatus, then circling the entire tree while overlapping the bottom of all the vertical members of each additional station, coming all the way around and across the apparatus, attaching the looped end of the strap to the attachment knob on the inside of the right vertical member of the station immediately clockwise to the apparatus, and then cinching the cam strap as tight as is physically possible.
